(19) United States
(12) Patent Application Publication
(10) Pub. No.: US 2025/0388034 A1
(43) Pub. Date: Dec. 25, 2025

(54) LIQUID DISCHARGE HEAD AND LIQUID DISCHARGE APPARATUS

(71) Applicant: CANON KABUSHIKI KAISHA, Tokyo (JP)

(72) Inventors: SATOSHI KIMURA, Kanagawa (JP); TAKUYA IWANO, Tokyo (JP); Klaas Verzijl, Tokyo (JP)

(21) Appl. No.: 19/238,256

(22) Filed: Jun. 13, 2025

(30) Foreign Application Priority Data
Jun. 20, 2024 (JP) 2024-099727

(51) Int. Cl. B41J 25/34

(52) U.S. Cl. CPC B41J 25/34

(57) ABSTRACT

A liquid discharge head includes a discharge element substrate including a discharge port array formed along a first direction, a support member configured to support the discharge element substrate, and a reference member configured to position the discharge element substrate with respect to a predetermined portion, wherein the reference member includes at least three reference members, wherein the support member includes, as a pressed portion configured to receive a force for pressing the predetermined portion, at least three pressed portions, and wherein a triangle formed by connecting reference points defined by the three reference members has a center of gravity inside a triangle formed by connecting the three pressed portions.

### BACKGROUND OF THE INVENTION

### Field of the Invention

The present disclosure relates to a liquid discharge head and a liquid discharge apparatus.

### Description of the Related Art

In recent years, with the increasing use of recording apparatus (hereinafter, also referred to as “liquid discharge apparatus” or simply as “apparatus”) in business, commercial, and industrial applications, liquid discharge heads (hereinafter, also referred to as “image recording head” or simply as “head”) may be configured to be replaceable. In this case, the liquid discharge head is required to be easily and accurately attachable to and detachable from the apparatus during replacement. Specifically, in order to preserve the inherent recording quality of the head, it is necessary for the liquid discharge head to be positioned with high accuracy on the liquid discharge apparatus. Japanese Patent Application Laid-Open No. 2023-148309 discusses a liquid discharge head that can be accurately positioned during mounting to a liquid discharge apparatus.

### SUMMARY OF THE INVENTION

According to an aspect of the present invention, a liquid discharge head includes a discharge element substrate including a plurality of discharge ports through which liquid is discharged, the plurality of discharge ports forming a discharge port array along a first direction, a support member on which the discharge element substrate is disposed, the support member being configured to support the discharge element substrate with respect to a predetermined portion, and a reference member disposed at the support member and configured to position the discharge element substrate with respect to the predetermined portion, wherein the reference member includes a first reference member and a second reference member disposed at a first end portion in a second direction orthogonal to the first direction so that the first reference member and the second reference member are positioned at different locations in the first direction, and a third reference member disposed at a second end portion opposite the first end portion in the second direction, wherein the support member includes, as a pressed portion configured to receive a force for pressing the predetermined portion, a first pressed portion and a second pressed portion disposed at the first end portion so that the first pressed portion and the second pressed portion are positioned at different locations in the first direction, and a third pressed portion at the second end portion, wherein a first triangle formed by connecting a first reference point defined by the first reference member, a second reference point defined by the second reference member, and a third reference point defined by the third reference member has a center of gravity inside a second triangle formed by connecting three points of the first pressed portion, the second pressed portion, and the third pressed portion.

Further features of the present invention will become apparent from the following description of embodiments with reference to the attached drawings.

### BRIEF DESCRIPTION OF THE DRAWINGS

FIG. 1 is a schematic view illustrating an example of a liquid discharge apparatus.

FIG. 2 is a perspective view illustrating the liquid discharge head.

FIG. 3 is a perspective view illustrating the liquid discharge head.

FIG. 4 is an exploded perspective view illustrating the liquid discharge head.

FIG. 5 is a diagram illustrating an electrical connection configuration of the liquid discharge head.

FIG. 6 is a perspective view illustrating a liquid discharge unit.

FIG. 7 is a perspective view illustrating the liquid discharge unit.

FIG. 8 is an exploded perspective view illustrating the liquid discharge unit.

FIG. 9 is an enlarged view illustrating an electrode portion of the liquid discharge unit.

FIG. 10 is a perspective view illustrating a support unit.

FIG. 11 is a plan view illustrating the liquid discharge head mounted on the support unit, as viewed from the discharge surface side.

FIG. 12 is a cross-sectional view along line XII-XII in FIG. 11.

FIG. 13 is a cross-sectional view along line XIII-XIII in FIG. 11.

FIG. 14 is a cross-sectional view along line XIV-XIV in FIG. 11.

FIGS. 15A and 15B are cross-sectional views illustrating a reference member and a positioning member of the liquid discharge head.

FIGS. 16A and 16B are diagrams illustrating a connection configuration of liquid flow paths of the support unit and a liquid supply unit.

FIG. 17 is a cross-sectional view illustrating a fluid connection portion of the liquid supply unit and a liquid supply member.

FIG. 18 is a diagram illustrating a connection configuration of the liquid flow paths of the support unit.

FIG. 19 is a diagram illustrating a connection configuration of the liquid flow paths of the liquid discharge unit.

FIG. 20 is a diagram illustrating a fluid connection configuration inside the discharge element substrate.

FIG. 21 is a perspective view illustrating a cooling unit configured to cool drive circuit substrates.

FIG. 22 is an exploded view illustrating the cooling unit.

FIG. 23 is a cross-sectional view along line XXIII-XXIII in FIG. 21.

FIGS. 24A and 24B are cross-sectional views illustrating an electrical connection portion of the body of the liquid discharge apparatus and the liquid discharge head.

FIG. 25 is a cross-sectional view illustrating the reference member.

FIG. 26 is a cross-sectional view illustrating a positioning portion of the liquid discharge head and the liquid discharge apparatus.

FIG. 27 is a plan view illustrating the liquid discharge head from below, showing the discharge port surface side.

FIG. 28 is a plan view illustrating the liquid discharge head from above.

FIG. 29 is a plan view illustrating the liquid discharge head from below, showing the discharge port surface side.

FIG. 30 is a cross-sectional schematic view illustrating a reference portion and a pressing portion.

FIG. 31 is a cross-sectional schematic view illustrating a reference portion and a pressing portion.

FIG. 32 is a perspective view illustrating a configuration for mounting the liquid discharge head on the liquid discharge apparatus.

### DESCRIPTION OF THE EMBODIMENTS

While highly accurate positioning is essential when mounting a liquid discharge head on a liquid discharge apparatus, it is also important to properly mount the liquid discharge head on the apparatus while maintaining the highly accurate positioning. This is because, even if highly accurate positioning is achieved, the inherent recording quality of the liquid discharge head cannot be maintained unless the liquid discharge head is mounted properly. Further, while the types of liquid discharge apparatuses on which the liquid discharge head is mounted vary depending on the intended use, it is preferable to ensure sufficient mounting flexibility to enable secure and stable mounting on any type of apparatus. In response to such a demand, Japanese Patent Application Laid-Open No. 2023-148309 fails to describe a configuration for securely and stably mounting the liquid discharge head after positioning the liquid discharge head with respect to the liquid discharge apparatus.

Thus, the present invention provides a liquid discharge head capable of suppressing a decrease in recording quality when securely and stably mounted on an apparatus. Further, a liquid discharge apparatus on which the liquid discharge head is mounted is also provided.

An embodiment of the present invention will be described with reference to the drawings. However, the following description is not intended to limit the scope of the present disclosure. While the present embodiment describes, as an example, a method for discharging liquid by driving a piezoelectric element, the present disclosure is also applicable to a liquid discharge head that employs a thermal method in which liquid is discharged using bubbles generated by a heater element, as well as to liquid discharge heads employing various other liquid discharge methods. In other words, the liquid discharge head can be defined as a head including any type of energy-generating element.

While an inkjet recording apparatus (recording apparatus) according to the present embodiment may be configured to circulate a liquid such as ink between a tank and a liquid discharge head, other configurations may also be employed. For example, tanks may be disposed upstream and downstream of a liquid discharge head, and ink may be transferred from one tank to the other tank to induce flow of the ink in a pressure chamber without circulating the ink. Further, an apparatus according to the present disclosure is not limited to a recording apparatus configured to discharge ink and may be defined as a liquid discharge apparatus configured to discharge any type of liquid.

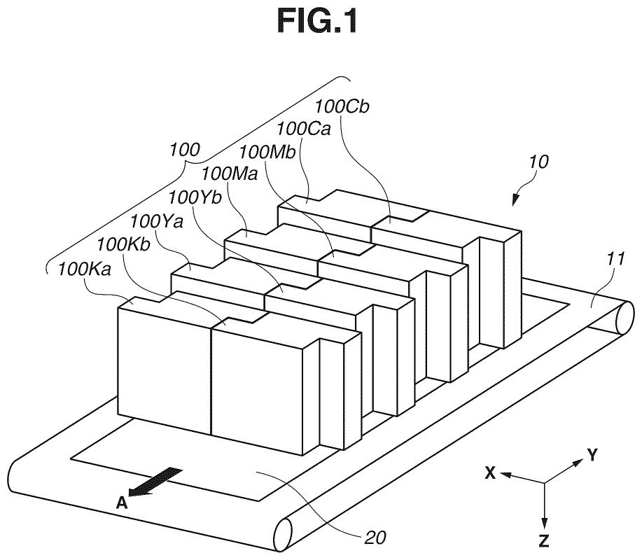

FIG. 1 is a schematic view illustrating an example of a liquid discharge apparatus 10 according to the present embodiment. The liquid discharge apparatus 10 includes a liquid discharge head 100. The liquid discharge head 100 is a so-called one-pass type liquid discharge head that completes image recording on a predetermined region of a recording medium 20 in a single pass of the recording medium 20.

The liquid discharge head 100 includes discharge ports arranged across a range corresponding to the full width (X direction in FIG. 1) of the recording medium 20. The recording medium 20 is conveyed in the direction of an arrow A by a conveyance portion 11, and the liquid discharge head 100 performs recording on the recording medium 20. The liquid discharge head 100 according to the present embodiment supports four colors in total: cyan, magenta, yellow, and black. More specifically, two heads are provided for each color. Specifically, cyan heads 100Ca and 100Cb, magenta heads 100Ma and 100Mb, yellow heads 100Ya and 100Yb, and black heads 100Ka and 100Kb are included. The following description will focus on one of the eight heads. Further, to simplify the description, one head will be described as the liquid discharge head 100. It should be noted that the liquid discharge head according to the present disclosure may have any configuration and is not limited to the example illustrated in FIG. 1.

Further, in the present embodiment, a liquid discharge direction (direction of gravity) is defined as the +Z direction, the upstream side in the conveyance direction of the recording medium 20 is defined as the +Y direction, and the arrangement direction of the discharge ports of the head is defined as the +X direction (first direction described below).

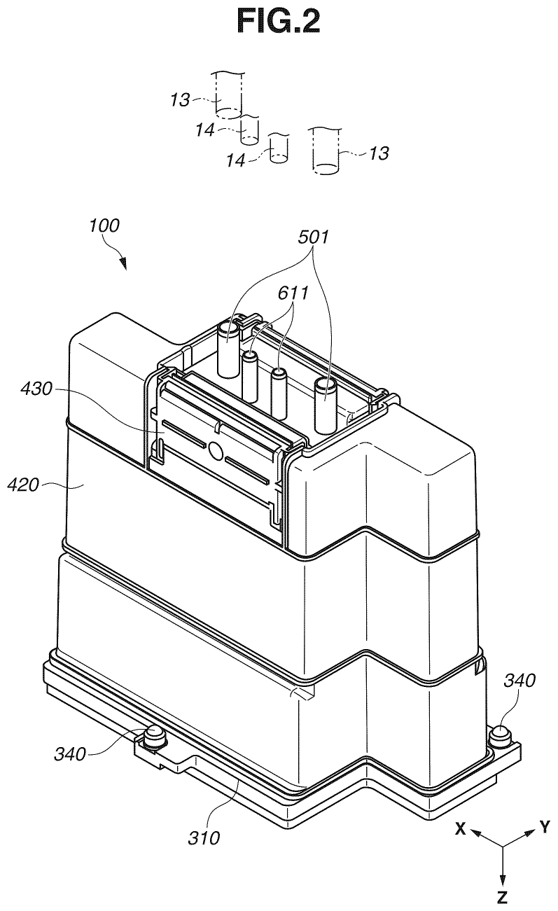

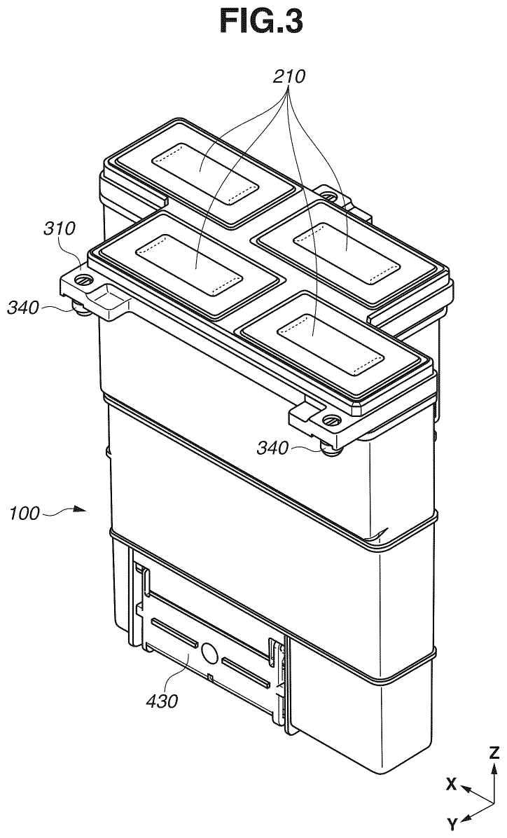

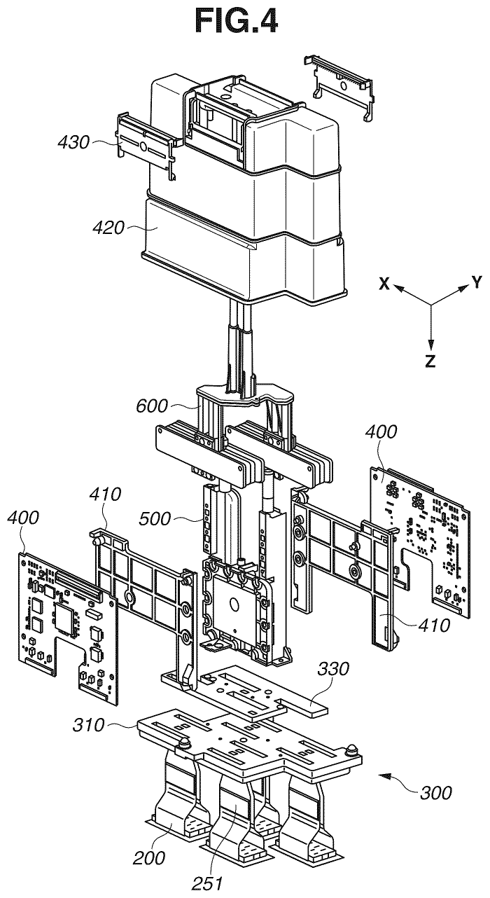

FIG. 2 is a perspective view illustrating the liquid discharge head 100 according to the present embodiment. FIG. 3 is a perspective view illustrating the liquid discharge head 100 according to the present embodiment as viewed from a direction different from that in FIG. 2. FIG. 4 is an exploded perspective view illustrating the liquid discharge head 100 according to the present embodiment. A configuration of the liquid discharge head 100 will be described with reference to FIGS. 2 to 4. As described above, one of the eight heads illustrated in FIG. 1 will be described as the liquid discharge head 100.

As illustrated in FIG. 3, the liquid discharge head 100 includes four discharge element substrates 210 arranged in a staggered pattern on a support member 310. Each discharge element substrate 210 is capable of discharging liquid. The liquid discharge head 100 is disposed on the body of the liquid discharge apparatus 10 using a reference member 340. As illustrated in FIG. 2, liquid connection portions 501 and refrigerant connection portions 611 are disposed on the upper part of the liquid discharge head 100. The liquid connection portions 501 are connected to liquid supply portions 13 of the body of the liquid discharge apparatus 10, and the refrigerant connection portions 611 are connected to refrigerant supply portions 14 of the body of the liquid discharge apparatus 10. This configuration allows a liquid, such as ink, and a refrigerant to be supplied from the body of the liquid discharge apparatus 10 into the liquid discharge head 100.

A covering member 420 and an electrical connection portion covering member 430 for protecting electrical substrates and electrical connection portions are disposed at an outer portion of the liquid discharge head 100. As illustrated in FIG. 4, the liquid discharge head 100 includes a support unit 300, electrical wiring boards 400, and electrical wiring board support members 410 supporting the electrical wiring boards 400. The support unit 300 includes the support member 310. Further, the liquid discharge head 100 includes a liquid supply unit 500, which supplies liquid to a liquid discharge unit 200, and a cooling unit 600, which cools a drive circuit. The liquid discharge head 100 includes the plurality of liquid discharge units 200. Specifically, four liquid discharge units 200 are included. A configuration of each part of the liquid discharge head 100 will be described in detail.

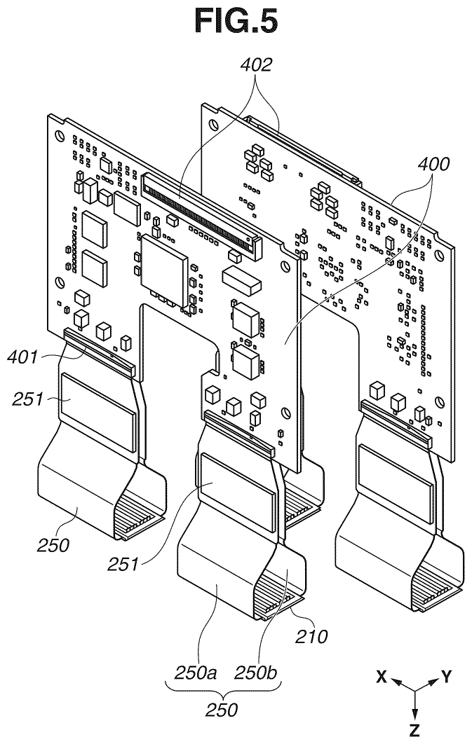

FIG. 5 is a diagram illustrating an electrical connection configuration of the liquid discharge head 100 according to the present embodiment. The body of the liquid discharge apparatus 10 and the discharge element substrates 210 are electrically connected via flexible wiring boards 250 and the electrical wiring boards 400. The electrical wiring boards 400 are electrically connected to a control unit (not illustrated) of the body of the liquid discharge apparatus 10 via electrical connection terminals 402. A discharge drive signal and power required for discharge are supplied to the electrical wiring boards 400 via the electrical connection terminals 402. The electrical wiring boards 400 and the flexible wiring boards 250 are electrically connected via electrical connection portions 401. The number of electrical connection terminals 402 can be reduced to less than the number of terminals of the discharge element substrates 210 by consolidating wiring via an electrical circuit in the electrical wiring boards 400. This reduces the number of electrical connection portions 401 that need to be removed to mount the liquid discharge head 100 on the liquid discharge apparatus 10 or to replace the liquid discharge head 100. Drive circuit substrates 251 configured to drive discharge elements of the discharge element substrates 210 are disposed on the flexible wiring boards 250. The drive circuit substrates 251 include drive elements for driving the discharge elements. Discharge drive signals fed to the electrical wiring boards 400 are input to the drive circuit substrates 251.

The drive circuit substrates 251 perform drive control to drive the recording elements based on the discharge drive signals. In the present embodiment, as illustrated in FIG. 5, each liquid discharge unit 200 is disposed with two flexible wiring boards 250: a first flexible wiring board 250a and a second flexible wiring board 250b. It should be noted that the terms “first flexible wiring board 250a” and “second flexible wiring board 250b” will be used to refer to individual flexible wiring boards, whereas the term “flexible wiring board 250” will be used when describing elements common to both.

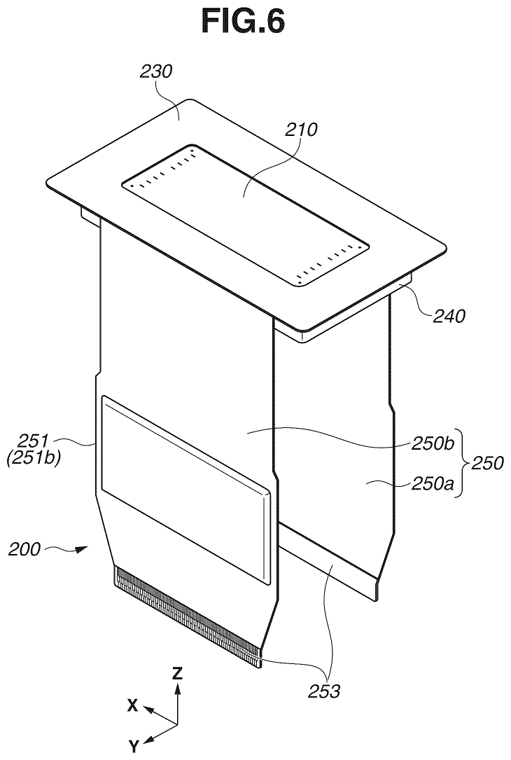

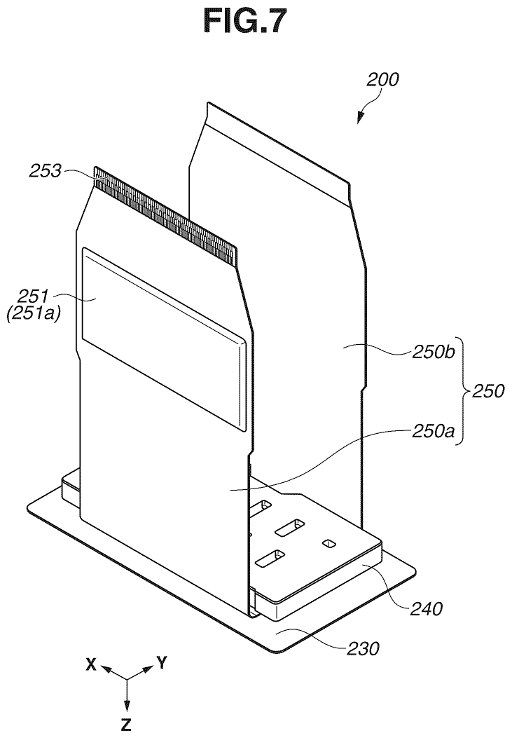

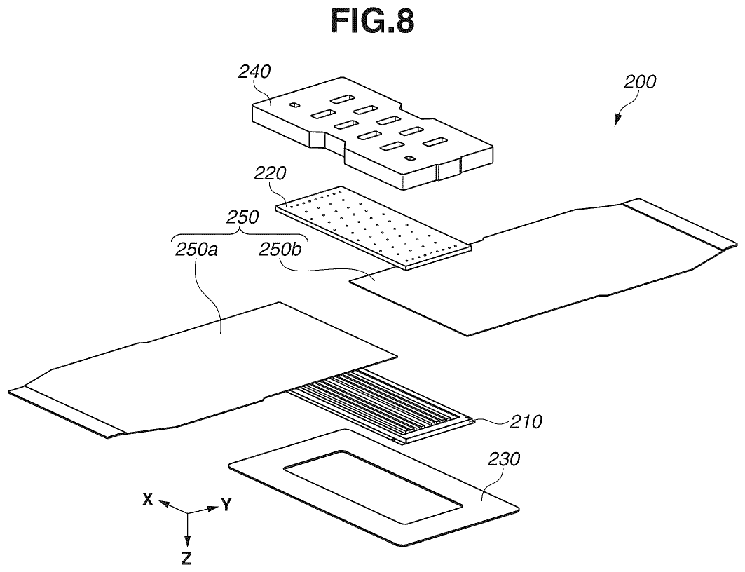

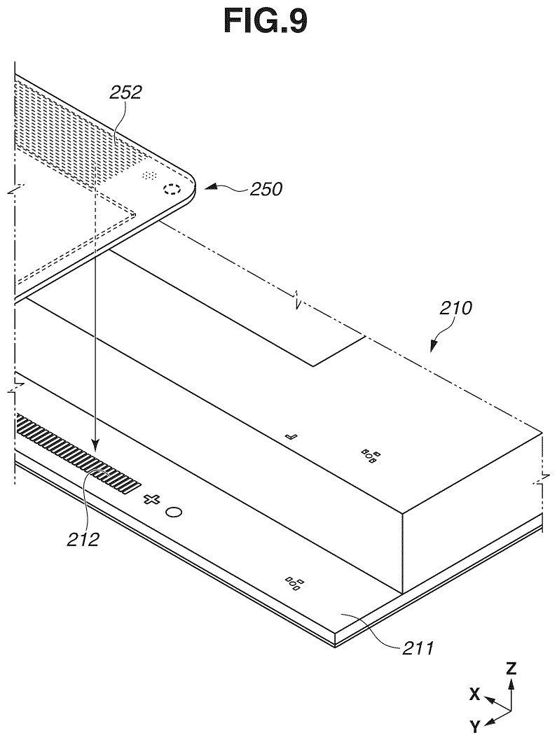

FIG. 6 is a perspective view illustrating the liquid discharge unit 200. FIG. 7 is a perspective view illustrating the liquid discharge unit 200. FIG. 8 is an exploded perspective view illustrating the liquid discharge unit 200. FIG. 9 is an enlarged view illustrating an electrode portion of the liquid discharge unit 200. A configuration of the liquid discharge unit 200 will be described with reference to FIGS. 6 to 9.

As illustrated in FIGS. 6 to 8, the liquid discharge unit 200 includes the discharge element substrate 210 configured to discharge liquid, a discharge element substrate flow path member 220 configured to supply liquid to the discharge element substrate 210, and a flow path member 240 configured to supply liquid to the discharge element substrate flow path member 220. Further, the flexible wiring board 250 and a discharge element substrate support member 230 are also included. The flexible wiring board 250 is electrically connected to the discharge element substrate 210, and the discharge element substrate support member 230 is joined to the discharge surface side of the discharge element substrate 210.

As illustrated in FIG. 9, thin plate portions 211 at both end portions of the discharge element substrate 210 include an electrode portion 212. FIG. 9 is an enlarged view illustrating one end portion of the discharge element substrate 210. It should be noted that the end portions refer to end portions in a direction intersecting the direction in which the discharge elements (or discharge ports) are arranged on the discharge element substrates 210. As illustrated in FIG. 9, the discharge element substrate 210 and the flexible wiring board 250 are electrically connected by bringing electrodes of the electrode portion 212 and a first electrical connection portion 252 of the flexible wiring board 250 into contact with each other. To prevent liquid ingress into this electrical connection portion and to reinforce the thin plate portions 211 of the discharge element substrate 210, the discharge element substrate support member 230 is joined to the discharge surface side of the thin plate portions 211, as illustrated in FIGS. 6 to 8. The drive circuit substrates 251 for driving the discharge elements of the discharge element substrates 210 are disposed at the flexible wiring boards 250 (refer to FIG. 5).

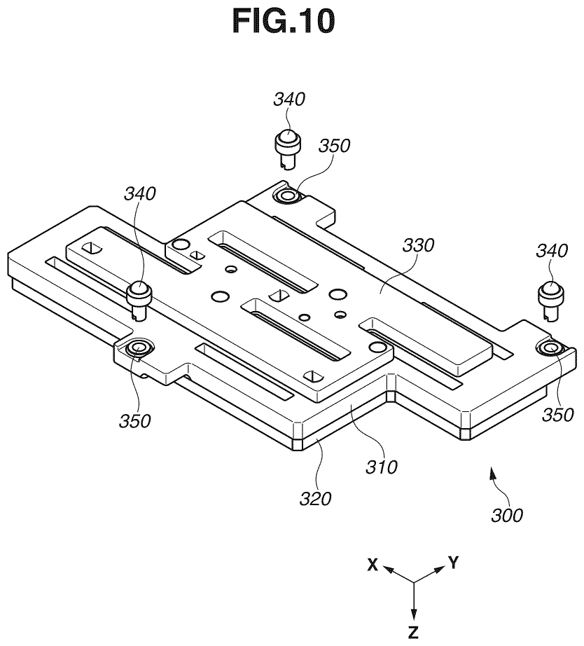

FIG. 10 is a perspective view illustrating the support unit 300 configured to support the liquid discharge units 200. The support unit 300 includes the support member 310 to which the liquid discharge units 200 are joined, and a frame member 320 that surrounds the periphery of the liquid discharge units 200. Further, a liquid supply member 330 is also included. The liquid supply member 330 includes a flow path formed to supply liquid to each liquid discharge unit 200 (four liquid discharge units 200 in the present embodiment) via the support member 310. Further, the reference members 340 having a function of positioning with respect to the body of the liquid discharge apparatus 10 and reference fixing members 350 used to fix the reference members 340 to the support member 310 are also included. It is preferable to select the same material for the support member 310, the frame member 320, and the liquid supply member 330, taking into account, for example, the effects of thermal expansion caused by ink heating for temperature control or by environmental fluctuations. In a case where different materials are used for the support member 310, the frame member 320, and the liquid supply member 330, it is desirable to select materials with coefficients of linear expansion that are as close as possible. This makes it possible to suppress deformation of the entire support unit 300 during thermal expansion and the resulting deterioration in the positional accuracy of the discharge element substrates 210.

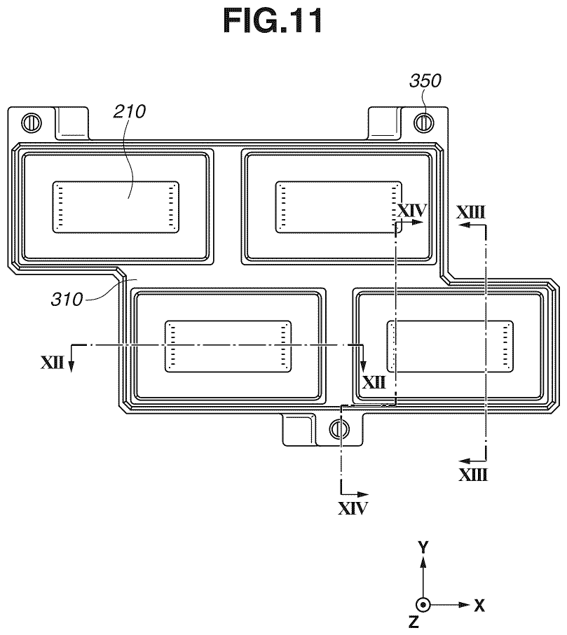

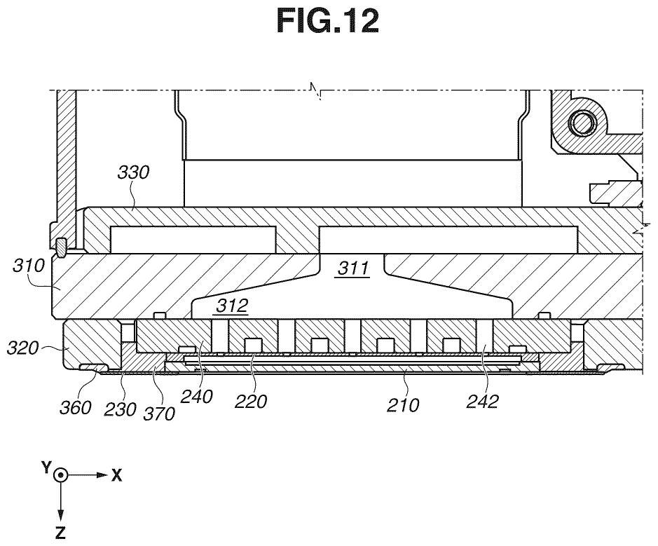

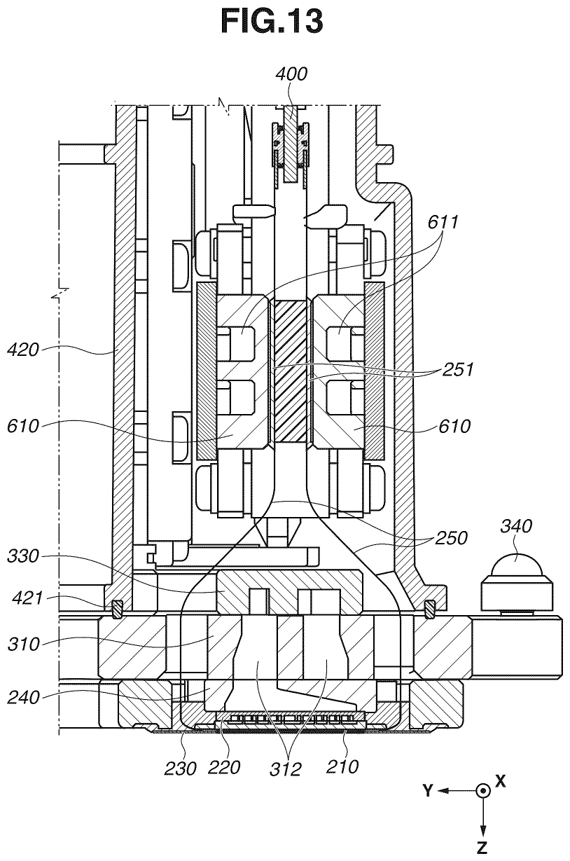

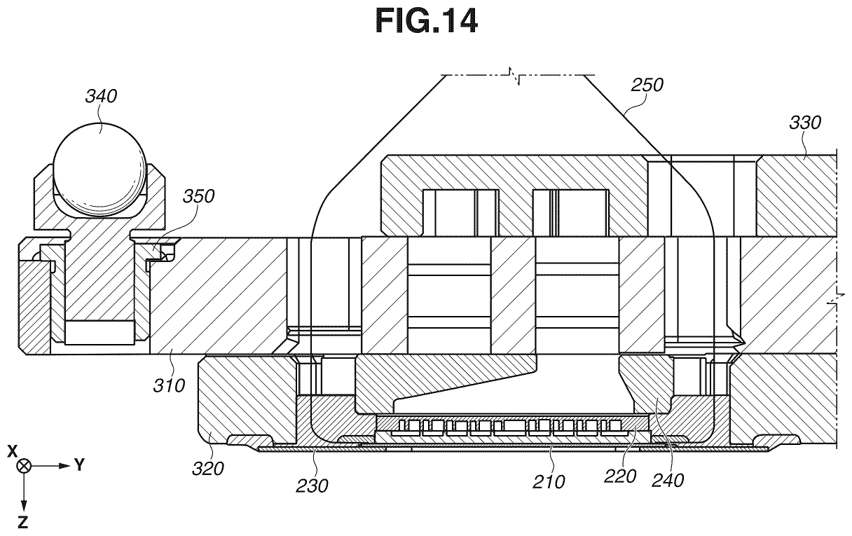

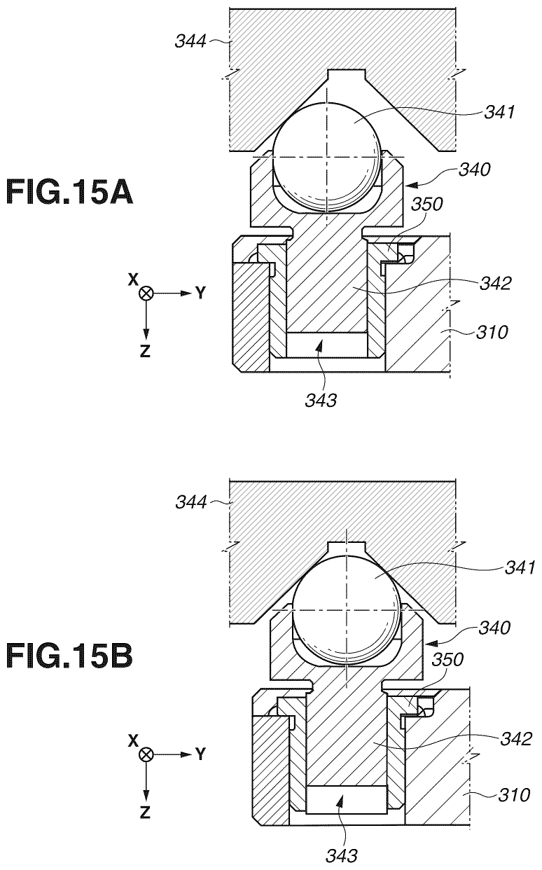

FIG. 11 is a plan view illustrating the liquid discharge head 100 with the liquid discharge units 200 mounted on the support unit 300, as viewed from the discharge surface side. FIG. 12 is a cross-sectional view along line XII-XII in FIG. 11. FIG. 13 is a cross-sectional view along line XIII-XIII in FIG. 11. FIG. 14 is a cross-sectional view along line XIV-XIV in FIG. 11. FIGS. 15A and 15B are cross-sectional views illustrating the reference member 340 and a positioning member 344 of the liquid discharge head 100. FIG. 15A is a diagram illustrating a state before positioning of the reference member 340, and FIG. 15B is a diagram illustrating a state after positioning of the reference member 340. It should be noted that FIG. 13 is a cross-sectional view along line XIII-XIII in FIG. 11 in a state where the liquid discharge unit 200 is mounted on the support unit 300 and then each member is mounted. As illustrated in FIGS. 12 to 14, the flow path member 240 and the liquid supply member 330 are joined to the support member 310, and liquid flow paths are fluidly connected. To suppress liquid ingress, the periphery of the discharge element substrate support member 230 is sealed by a peripheral sealing member 380 between the discharge element substrate support member 230 and the frame member 320. The back surface (surface opposite the discharge port surface) of the discharge element substrate support member 230 may be sealed by a back surface sealing member 370 for reinforcement. As illustrated in FIG. 11, the support member 310 includes three holes into which the reference fixing members 350 are inserted. The reference fixing members 350 are configured to be fixed to the holes, and the reference members 340 are configured to be fixed to the reference fixing members 350. The reference fixing members 350 may be an integral part of the support member 310. As illustrated in FIGS. 15A and 15B, a spherical portion of a positioning portion 341 of the reference member 340 is disposed by a conical portion of the positioning member 344 of the liquid discharge apparatus 10, thereby centering the reference member 340 within the positioning member 344. Bringing the spherical portion of the positioning portion 341 into contact with the positioning member (predetermined portion) 344 enables positioning by constraining the translational degrees of freedom in three directions (X, Y, and Z directions in the figures).

Desirably, the positioning portion 341 is substantially spherical, and bringing three points on the surface of the spherical body into contact with a groove or the conical portion of the positioning member 344 of the liquid discharge apparatus 10 enables positioning by constraining the translational degrees of freedom in three directions (X, Y, and Z directions). Further, in the present embodiment, the spherical body of the reference member 340 is brought into contact with the liquid discharge head 100 by moving the spherical body in the direction opposite the liquid discharge direction. This configuration facilitates reduction of the distance between the discharge element substrates 210 and the recording medium 20, enabling highly-accurate printing.

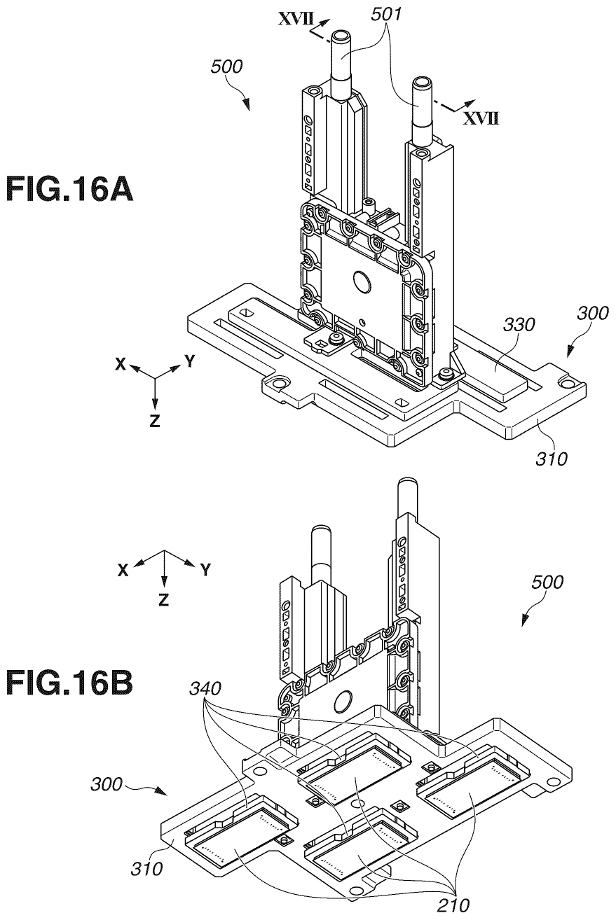

FIGS. 16A and 16B are diagrams illustrating a connection configuration of the liquid flow paths of the support unit 300 and the liquid supply unit 500 of the liquid discharge head 100 according to the present embodiment. FIG. 16A is a perspective view from above. FIG. 16B is a perspective view from below. The liquid supply unit 500 includes the liquid connection portions 501, and the liquid connection portions 501 are connected to the liquid supply portions 13 (FIG. 2) of the body of the liquid discharge apparatus 10. With this configuration, liquid is supplied from a supply system of the body of the liquid discharge apparatus 10 to the liquid discharge head 100, and the liquid that has passed through the liquid discharge head 100 is returned to the supply system of the body of the liquid discharge apparatus 10. Thus, the liquid can circulate through the paths of the body of the liquid discharge apparatus 10 and the liquid discharge head 100. To remove foreign substances from the supplied ink, a filter (not illustrated) in communication with each opening of the liquid connection portions 501 is disposed inside the liquid supply unit 500.

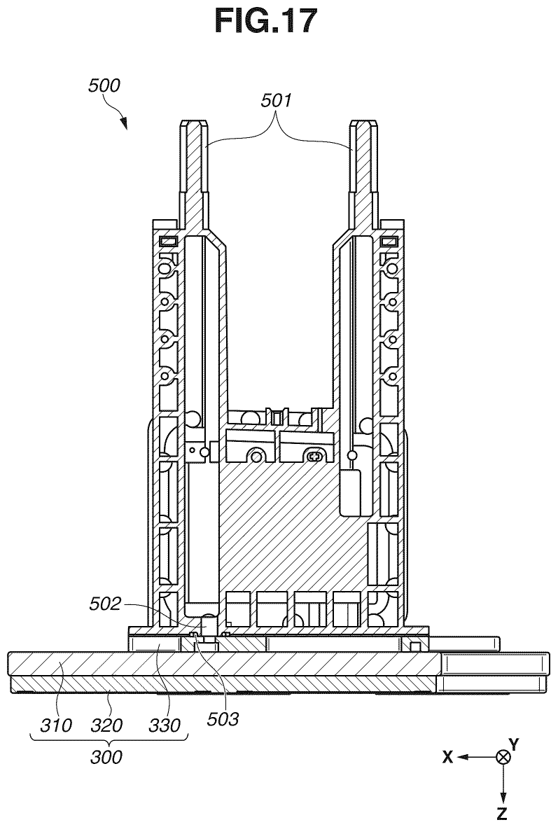

FIG. 17 is a cross-sectional view illustrating a fluid connection portion of the liquid supply unit 500 and the liquid supply member 330. FIG. 17 is a cross-sectional view along line XVII-XVII in FIG. 16A. Liquid that has flowed in from the body of the liquid discharge apparatus 10 through the liquid connection portions 501 passes through a communication port 502 and is supplied to the liquid supply member 330. The space between the liquid supply unit 500 and the liquid supply member 330 is sealed by elastic member 503.

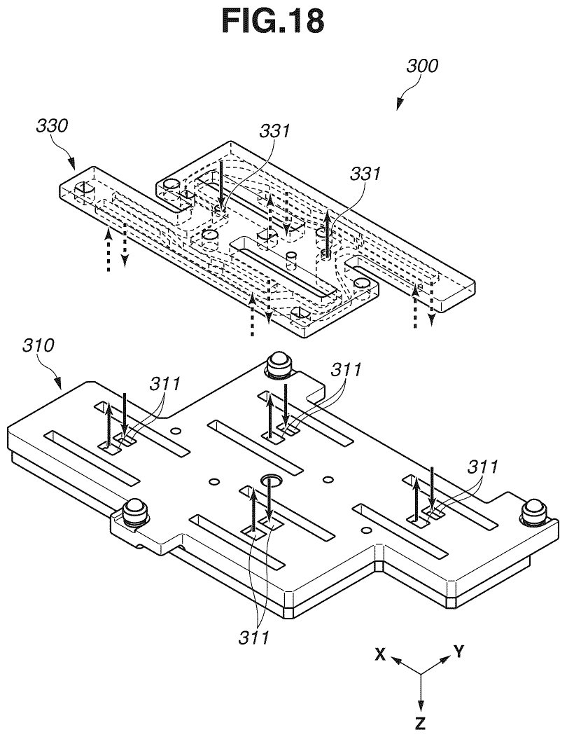

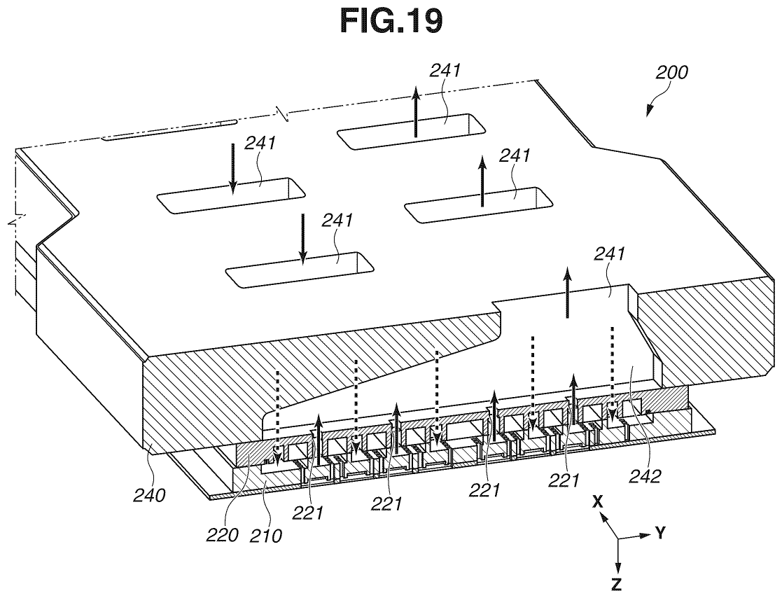

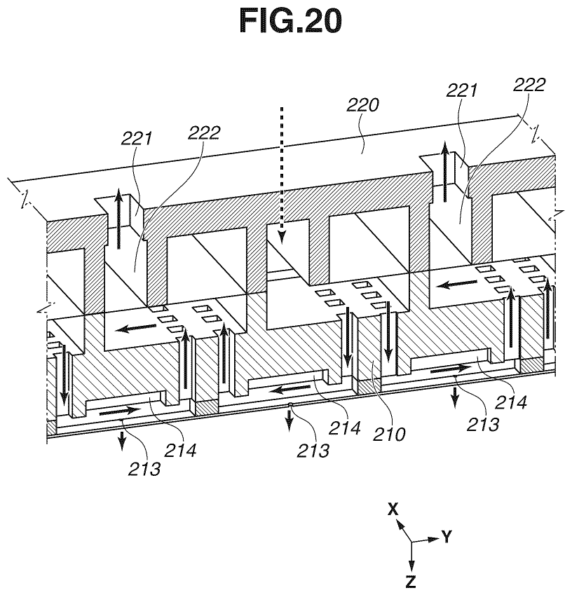

FIG. 18 is a diagram illustrating a connection configuration of the liquid flow paths of the support unit 300. FIG. 19 is a diagram illustrating a connection configuration of the liquid flow paths of the liquid discharge unit 200. The liquid supply unit 500 and the liquid supply member 330 in the support unit 300 are fluidly connected via first communication ports 331. In the liquid supply member 330, flow paths are formed to distribute liquid to the liquid discharge units 200. In this example, flow paths configured to distribute liquid to four liquid discharge units 200 are formed within the single liquid supply member 330. The liquid supply member 330 and the support member 310 are fluidly connected through second communication ports 311. The support member 310 and each liquid discharge unit 200 are fluidly connected through third communication ports 241 of the flow path member 240, as illustrated in FIG. 19. Liquid flow paths 242 are formed in the flow path member 240. The flow path member 240 is fluidly connected to the discharge element substrate flow path member 220 via fourth communication ports 221. FIG. 20 is a diagram illustrating a fluid connection configuration inside the discharge element substrate 210. Liquid that has flowed in via the fourth communication ports 221 passes through common flow paths 222, is supplied to the discharge element substrate 210, and is then discharged from discharge ports 213 by piezoelectric elements 214.

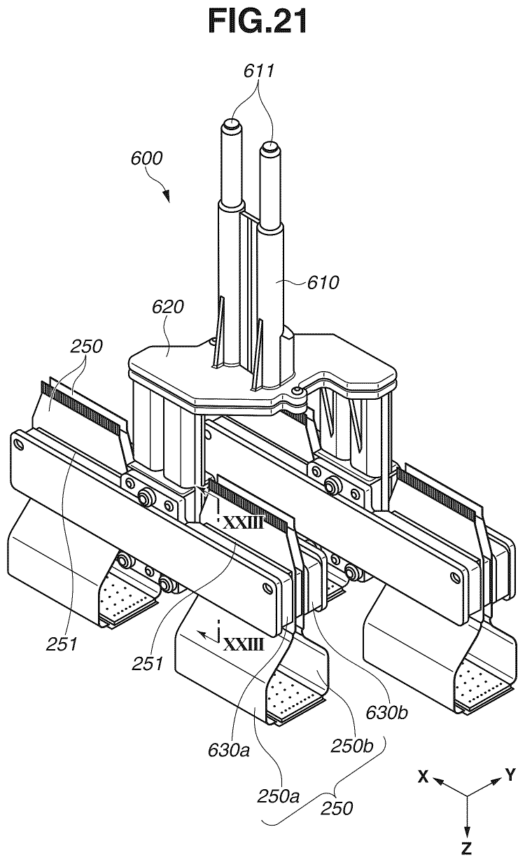

FIG. 21 is a perspective view illustrating the cooling unit 600 configured to cool the drive circuit substrates 251.

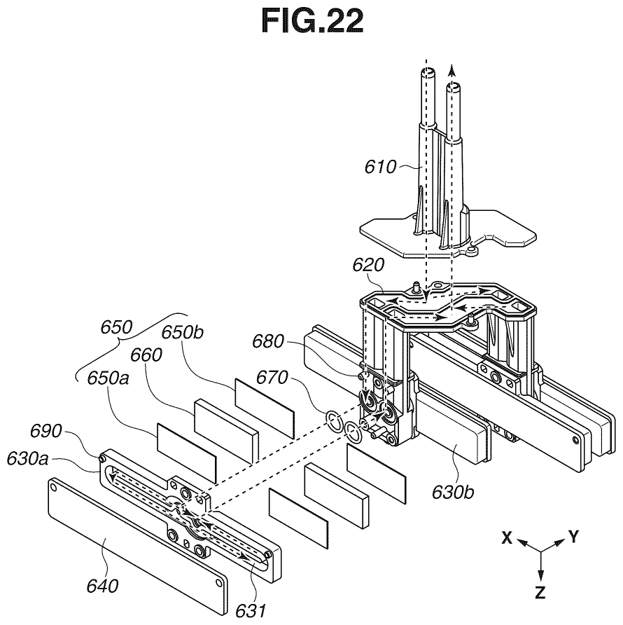

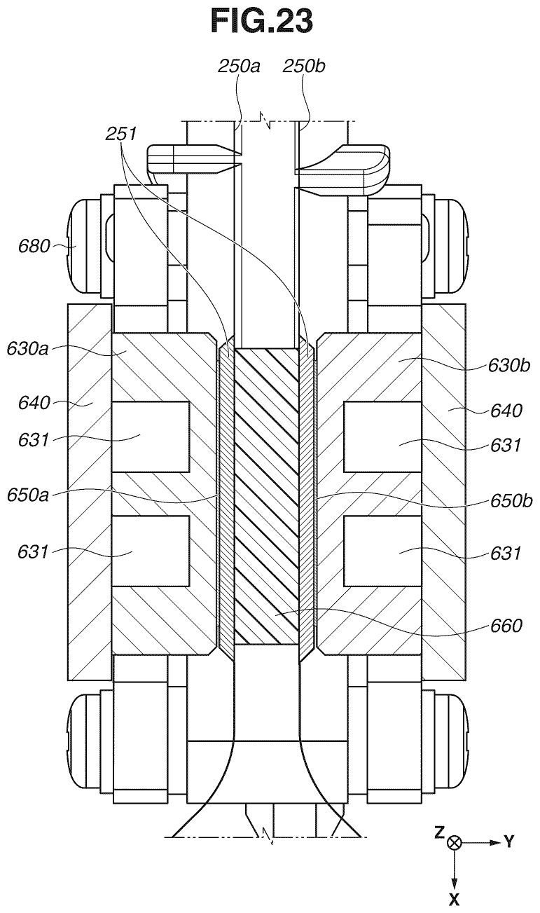

FIG. 22 is an exploded view illustrating the cooling unit 600. FIG. 23 is a cross-sectional view along line XXIII-XXIII in FIG. 21. As described above, the drive circuit substrates 251 are disposed at the flexible wiring boards 250 (refer to FIG. 5). FIG. 21 is a diagram illustrating a state where the drive circuit substrates 251 are covered by the cooling unit 600. As illustrated in FIG. 21, the cooling unit 600 includes the refrigerant connection portions 611. The refrigerant connection portions 611 are connected to the refrigerant supply portions 14 (FIG. 2) of the body of the liquid discharge apparatus 10. With this configuration, the refrigerant is supplied from a refrigerant supply system of the body of the liquid discharge apparatus 10 to the cooling unit 600, and the refrigerant that has passed through the cooling unit 600 is returned to the refrigerant supply system of the body of the liquid discharge apparatus 10. Thus, the refrigerant can circulate through the paths of the body of the liquid discharge apparatus 10 and the cooling unit 600. The refrigerant that has flowed in via the refrigerant connection portions 611 is branched via a refrigerant flow path formed between a first refrigerant supply member 610 and a second refrigerant supply member 620, as illustrated in FIG. 22. The second refrigerant supply member 620 and a cooling member 630 are fluidly connected via a sealing member 670. The refrigerant branched in the second refrigerant supply member 620 circulates within a refrigerant flow path 631 formed between the cooling member 630 and a cover member 640. Then, the refrigerant flows into the second refrigerant supply member 620 again, merges through the refrigerant flow path formed between the first refrigerant supply member 610 and the second refrigerant supply member 620, and flows out from the refrigerant connection portions 611. The second refrigerant supply member 620 and the cooling member 630 are fixed by a first fixing member 680. The cooling member 630 and the cover member 640 are fixed by a second fixing member 690.

The cooling unit 600 according to the present embodiment includes four sets of the cooling member 630 and the cover member 640. The second refrigerant supply member 620 is divided into two cooling systems along the Y direction. Each cooling system includes two sets of the cooling member 630 and the cover member 640. These two sets are disposed to face each other along the Y direction. Further, a thermal conduction member 650 configured to be brought into contact with the cooling member 630 is disposed between the two sets along the Y direction.

The cooling unit 600 according to the present embodiment includes four cooling members 630. In FIGS. 21 and 22, the cooling member 630 to which the refrigerant is supplied from the branched second refrigerant supply member 620 on the front-left side of FIGS. 21 and 22 will be referred to as a first cooling member 630a and a second cooling member 630b, as viewed from the front-left side of FIGS. 21 and 22. It should be noted that the terms “first cooling member 630a” and “second cooling member 630b” will be used to refer to individual cooling members, whereas the term “cooling member 630” will be used when describing elements common to both. Further, the thermal conduction member 650 that is brought into contact with the first cooling member 630a will be referred to as a first thermal conduction member 650a. The thermal conduction member 650 that is brought into contact with the second cooling member 630b opposite the first cooling member 630a will be referred to as a second thermal conduction member 650b.

As described above, the first cooling member 630a and the second cooling member 630b are disposed opposite to each other. As illustrated in FIG. 22, the cooling unit 600 includes an elastic member 660 between the first thermal conduction member 650a and the second thermal conduction member 650b. It should be noted that the flexible wiring boards 250 having the drive circuit substrates 251 disposed thereon are provided between the thermal conduction members 650 and the elastic members 660 as illustrated in FIG. 21, and the thermal conduction members 650 are brought into contact with the drive circuit substrates 251 (refer to FIGS. 21 and 23). Further, the first cooling members 630a and the second cooling members 630b are pressed against the second refrigerant supply member 620 and fixed by the first fixing members 680.

With this configuration, the cooling members 630 are brought into contact with the drive circuit substrates 251 with thermal conduction members 650 therebetween, thereby transmitting heat generated during the operation of the drive circuit substrates 251 to the refrigerant in the cooling members 630. To facilitate transmission of the heat generated at the drive circuit substrates 251, it is desirable to select a material with as high a thermal conductivity as possible, such as aluminum, for the cooling members 630. The elastic member 660 is disposed between each set of two flexible wiring boards 250 to ensure close contact between the thermal conduction members 650 and the drive circuit substrates 251.

As illustrated in FIG. 21, two flexible wiring boards 250 each including the drive circuit substrate 251 extend from each discharge element substrate 210 along a-Z direction. The two flexible wiring boards 250 are arranged to face each other in the direction intersecting a discharge port array direction in which the discharge ports 213 are formed. More specifically, the two flexible wiring boards 250 are arranged so that the drive circuit substrates 251 face outward. The thermal conduction members 650 are brought into contact with the sides (outer sides) of the flexible wiring boards 250 on which the drive circuit substrates 251 are disposed, and the elastic members 660 are brought into contact with the sides (inner sides) opposite to the sides on which the drive circuit substrates 251 are disposed. Then, the cooling members 630 are brought into contact with outer sides of the thermal conduction members 650 to sandwich the thermal conduction members 650. As a result, the drive circuit substrates 251 are cooled efficiently. In the present embodiment, each cooling member (630a, 630b) is configured to cool the drive circuit substrates 251 of the plurality of discharge element substrates 210, as illustrated in FIG. 21.

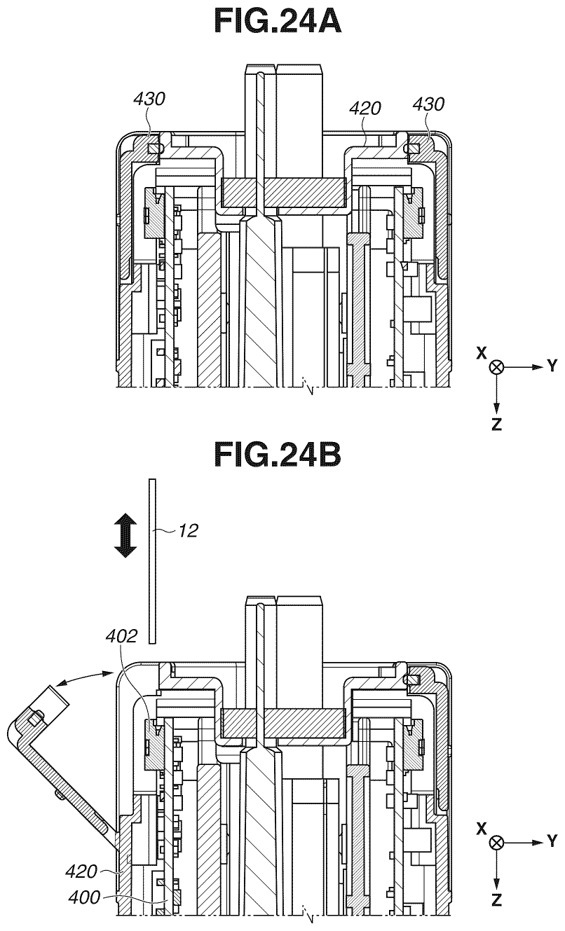

FIGS. 24A and 24B are cross-sectional views illustrating an electrical connection portion of the body of the liquid discharge apparatus 10 and the liquid discharge head 100. Each electrical wiring board 400 in the liquid discharge head 100 includes the electrical connection terminal 402. By connecting a liquid discharge apparatus electrical wiring portion 12 to the electrical connection terminal 402, the liquid discharge apparatus 10 and the liquid discharge head 100 are electrically connected. The peripheries of the electrical connection terminals 402 are covered by the electrical connection portion covering members 430 configured to be opened and closed.

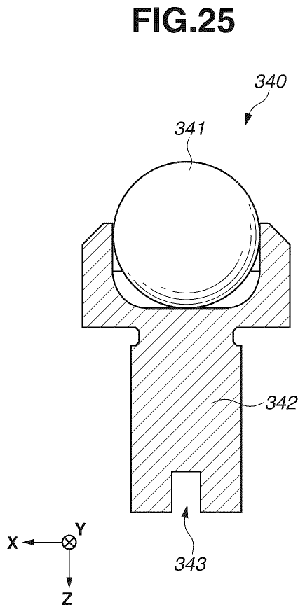

FIG. 25 is a cross-sectional view illustrating the reference member 340. The reference member 340 includes the positioning portion 341, an adjustment portion 342, and a recessed portion 343. The positioning portion 341 is brought into contact with the positioning member 344 (refer to FIGS. 15A and 15B) of the liquid discharge apparatus 10 to achieve positioning. In the present embodiment, the positioning portion 341 of the reference members 340 has a spherical shape, and the positioning member 344 of the liquid discharge apparatus 10 has a recessed shape. While the reference member 340 and the spherical portion of the positioning portion 341 are separate members in the present embodiment, the reference member 340 and the spherical portion of the positioning portion 341 may be formed as a single integrated structure.

In a case where the positioning portion 341 having the spherical shape is formed as a separate member, methods such as press-fitting or adhesive bonding may be employed for joining. The lower the surface roughness of the spherical portion of the positioning portion 341 and the positioning member 344 of the liquid discharge apparatus 10, the better the slip characteristics in positioning with respect to the positioning member 344 of the liquid discharge apparatus 10, enabling highly accurate positioning. For example, the surface roughness of the positioning portion 341 and the positioning member 344 is Ra 0.1 μm or less. Further, it is desirable to use alumina as a material for the spherical portion of the positioning portion 341 to suppress positional deviation caused by linear expansion.

Further, the liquid discharge apparatus 10 according to the present embodiment includes the adjustment portion 342 used to adjust the distance between the positioning portion 341 and the discharge element substrate 210. In the present embodiment, the adjustment portion 342 has an external thread shape, and the reference fixing member 350 (refer to FIGS. 15A and 15B) has an internal thread shape, thereby enabling adjustment of the height in the liquid discharge direction of the discharge element substrate 210. It should be noted that this configuration is not a limitation, and the relationship between the external thread and the internal thread may be reversed, or methods other than threads may be used for height adjustment.

In the present embodiment, the height of the positioning portion 341 in the liquid discharge direction of the discharge element substrate 210 can be adjusted from the direction opposite to the insertion direction of the reference fixing member 350 with respect to the support member 310. The height of the positioning portion 341 can be adjusted by adjusting the recessed portion 343 of the adjustment portion 342 using a tool such as a screwdriver or a hex wrench, and the shape of the recessed portion 343 may be, for example, a cross slot, a hexagonal hole, or a slotted hole. Further, adjustments can also be made by adding a raised shape to the recessed portion 343.

In the present embodiment, the positioning portion 341 of the reference member 340 of the liquid discharge head 100 has the spherical shape, and positioning is achieved by the positioning portion 341 and the recessed portion 343 of the positioning member 344 of the liquid discharge apparatus 10. Conversely, the reference member 340 of the liquid discharge head 100 may have a recessed or groove shape, and the positioning member 344 of the liquid discharge apparatus 10 may have a spherical shape.

By providing the reference members 340 to the liquid discharge head 100, the distance between the liquid discharge head 100 and the recording medium 20 set on the liquid discharge apparatus 10 is reduced, thereby achieving a reduction in the size of the liquid discharge head 100.

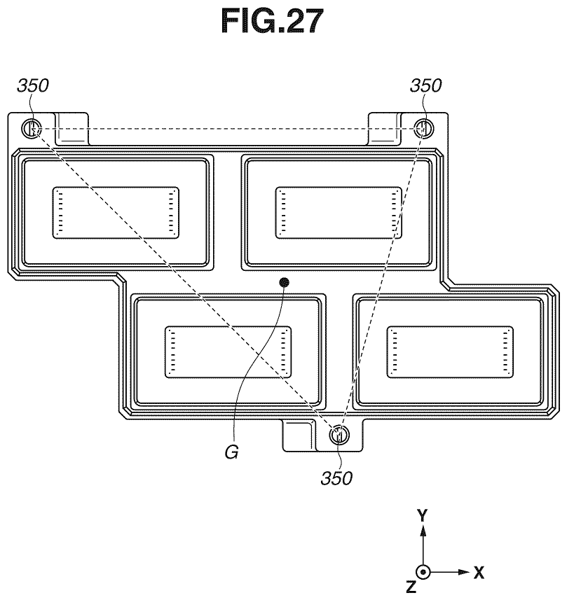

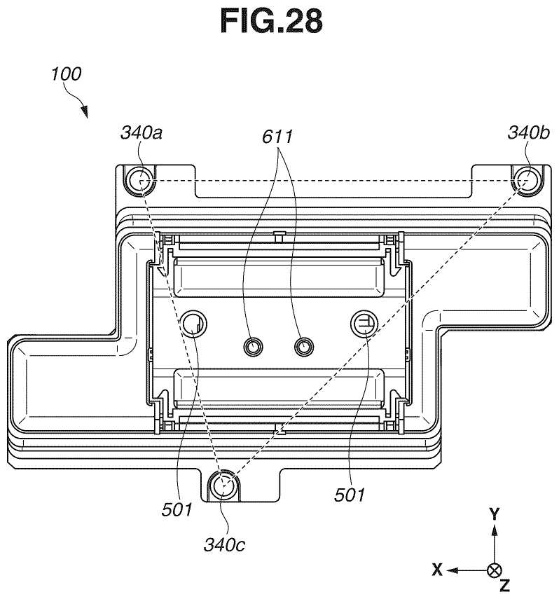

FIG. 27 is a plan view illustrating the liquid discharge head 100 from below, showing the discharge port surface side, and FIG. 28 is a plan view illustrating the liquid discharge head 100 from above. As illustrated in FIG. 27, the liquid discharge head 100 includes three reference fixing members 350. Two reference fixing members 350 (first and second reference fixing members) are disposed at one end portion in a second direction (Y direction in FIG. 27) intersecting the X direction (arrangement direction of the plurality of discharge ports, first direction), and one reference fixing member 350 (third reference fixing member) is disposed at the opposite end portion, at a position between the two reference fixing members 350 at the one end portion in the X direction (first direction).

Since there is only one plane that passes through three points simultaneously, it is known that supporting an object at three points provides the greatest stability. Thus, by providing three reference fixing members 350 to support the liquid discharge head 100 at three points as in the present embodiment, the liquid discharge head 100 is supported stably. Further, it is desirable to configure the liquid discharge head 100 so that a center of gravity G of the liquid discharge head 100 is inside a triangle formed by the three reference fixing members 350 (first, second, and third reference fixing members) as vertices in the plane viewed from the discharge surface side, as illustrated in FIG. 27, because this configuration facilitates ensuring stability during fixation. It should be noted that the reference fixing members 350 may be disposed at a minimum of three points or may be disposed at four or more points.

Further, as illustrated in FIG. 28, the reference members 340 at the respective reference positions on the liquid discharge head 100 are a first reference member 340a, a second reference member 340b, and a third reference member 340c. The liquid connection portions 501 and the refrigerant connection portions 611 are then arranged inside a triangle (first triangle) formed by connecting three reference points defined by the three reference members 340 in a plan view of the liquid discharge head 100 from above. This arrangement ensures the stability of the connection portions and the reference portions.

As described above, at least two reference members are disposed at one end portion in the Y direction intersecting the X direction, and at least one reference member is disposed at the opposite end portion, at a position between the two reference members at the one end portion in the X direction. Furthermore, the reference members include the adjustment portions, and the adjustment portions can adjust the positions of the discharge element substrates in the liquid discharge direction.

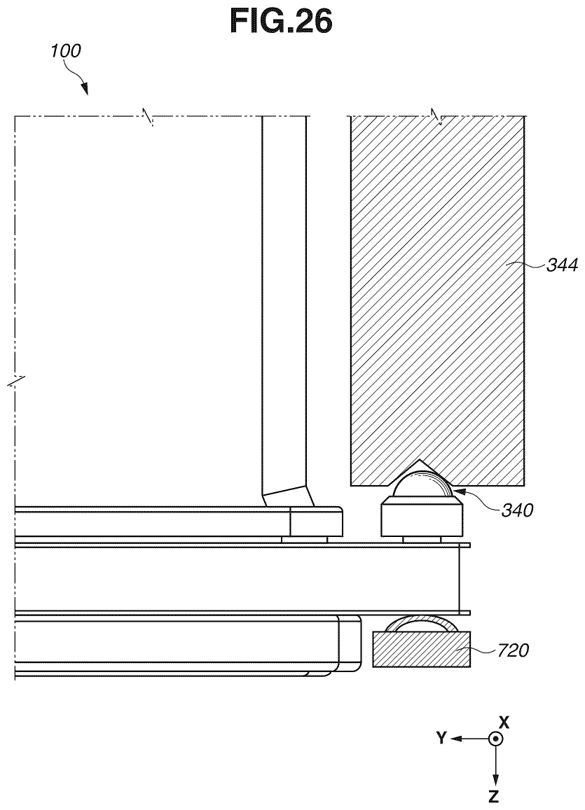

FIG. 26 is a cross-sectional view illustrating a positioning portion of the liquid discharge head 100 and the liquid discharge apparatus 10. The positioning member 344 includes a recessed portion configured to receive the reference member 340. A pressing member 720 presses the liquid discharge head 100 against the positioning member 344, thereby fixing the liquid discharge head 100 to the liquid discharge apparatus 10. Desirably, the pressing member 720 is an elastic member, such as a rubber or spring member. In the present embodiment, the positioning member 344 of the liquid discharge apparatus 10 has a groove or conical shape, and the positioning portion 341 of the reference member 340 is spherical and pressed against the positioning member 344. This enables easy and highly accurate positioning of the liquid discharge head 100. Desirably, the pressing direction of the pressing member 720 is an axis direction that includes the liquid discharge direction. While pressing along the same axis as the reference member 340 is most effective, the configuration of the liquid discharge apparatus imposes constraints. Therefore, pressing does not need to be along the same axis as the reference member 340, as long as the positional relationship of the pressing member ensures accurate positioning.

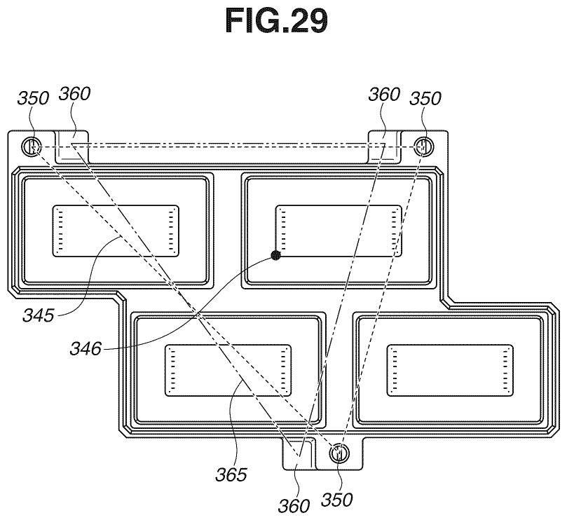

FIG. 29 illustrates an example of a positional relationship between pressed portions 360 and the reference members 340. In FIG. 29, the pressed portions 360 and the reference members 340 are disposed adjacent to each other. In other words, a first pressed portion is disposed near the first reference member, a second reference member is disposed near the second pressed portion, and a third reference member is disposed near the third pressed portion.

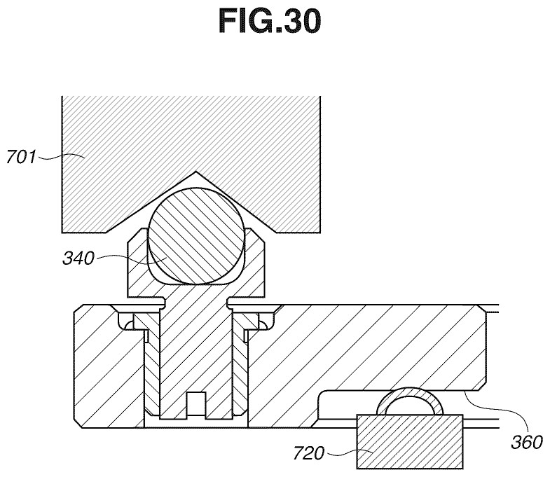

FIG. 30 is a cross-sectional schematic view illustrating a pressing portion in this case. By positioning the pressed portion 360 not on the same axis as the reference member 340 but at an adjacent or separated position, the position in the discharge direction can also be changed, as illustrated in FIG. 30. Thus, the design flexibility of the arrangement and configuration of the pressing member 720 is improved. Desirably, the pressed portion 360 is disposed near the reference member 340. However, stable positioning of the reference member 340 can be achieved by pressing the center of gravity of the first triangle formed by connecting the three reference points defined by the three reference members. Therefore, stable positioning of the reference member 340 can be achieved in a case where the first triangle has a center of gravity inside a second triangle formed by connecting the three pressed portions (i.e., first, second, and third pressed portions). In other words, a first triangle 345 formed by connecting the first, second, and third reference points respectively defined by the first, second, and third reference members has a center of gravity 346 inside a second triangle 365 formed by connecting three points of the first, second, and third pressed portions. Furthermore, it is desirable that the third pressed portion be disposed, with respect to the third reference member, in a direction toward a midpoint of a line segment connecting the first and second reference members in the first direction.

Depending on the apparatus configuration, it may be difficult to provide the pressed portion 360 adjacent to the reference member 340, as in this example, and the pressed portion 360 may need to be disposed at a more distant position in the first direction. Even in such a case, the pressed portion 360 may be separated within a range in which the center of gravity of the first triangle is inside the second triangle, and the centers of gravity of the first and second triangles are spaced apart in the first direction. In this case, the difference between the centers of gravity of the first and second triangles in the first direction is desirably one-sixth or less of a line segment connecting two reference members located on the side having two reference members in the second direction.

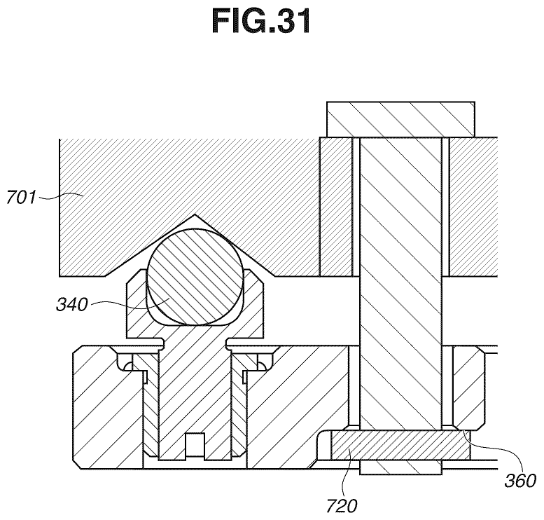

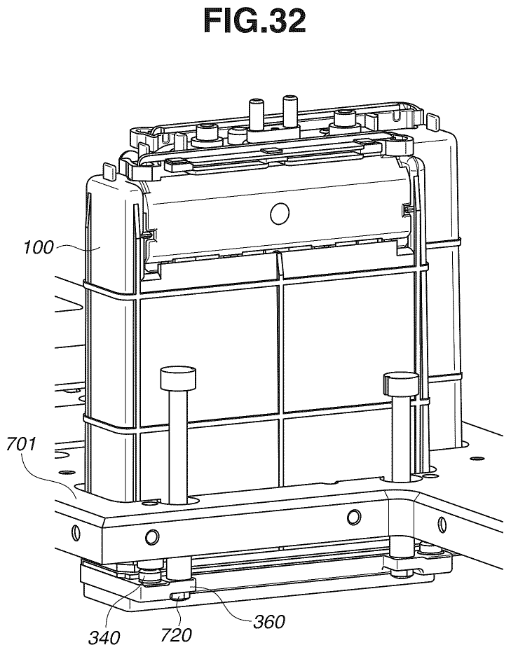

Further, the pressing method is not limited to pressing the pressed portions 360 forming the surface with an elastic member, and similar effects can also be achieved using other pressing methods. For example, as illustrated in FIG. 31, the pressed portion 360 may include an opening and may be pressed by a screw passing through the opening. FIG. 32 is a perspective view illustrating an example of an apparatus configuration.

While the present invention has been described with reference to embodiments, it is to be understood that the invention is not limited to the disclosed embodiments but is defined by the scope of the following claims.

This application claims the benefit of Japanese Patent Application No. 2024-099727, filed Jun. 20, 2024, which is hereby incorporated by reference herein in its entirety.

What is claimed is:

1. A liquid discharge head comprising:
a discharge element substrate including a plurality of discharge ports through which liquid is discharged, the plurality of discharge ports forming a discharge port array along a first direction;
a support member on which the discharge element substrate is disposed, the support member being configured to support the discharge element substrate with respect to a predetermined portion; and
a reference member disposed at the support member and configured to position the discharge element substrate with respect to the predetermined portion,
wherein the reference member includes:
a first reference member and a second reference member disposed at a first end portion in a second direction orthogonal to the first direction so that the first reference member and the second reference member are positioned at different locations in the first direction; and
a third reference member disposed at a second end portion opposite the first end portion in the second direction,
wherein the support member includes, as a pressed portion configured to receive a force for pressing the predetermined portion:
a first pressed portion and a second pressed portion disposed at the first end portion so that the first pressed portion and the second pressed portion are positioned at different locations in the first direction; and
a third pressed portion at the second end portion,
wherein a first triangle formed by connecting a first reference point defined by the first reference member, a second reference point defined by the second reference member, and a third reference point defined by the third reference member has a center of gravity inside a second triangle formed by connecting three points of the first pressed portion, the second pressed portion, and the third pressed portion.

2. The liquid discharge head according to claim 1, wherein the third reference member is disposed between the first reference member and the second reference member in the first direction.

3. The liquid discharge head according to claim 1, wherein the third pressed portion is disposed between the first pressed portion and the second pressed portion in the first direction.

4. The liquid discharge head according to claim 1, wherein the first reference member and the first pressed portion are disposed adjacent to each other, the second reference member and the second pressed portion are disposed adjacent to each other, and the third reference member and the third pressed portion are disposed adjacent to each other.

5. The liquid discharge head according to claim 1,
wherein the third reference member is disposed between the first reference member and the second reference member in the first direction,
wherein the third pressed portion is disposed between the first pressed portion and the second pressed portion in the first direction, and
wherein the first reference member and the first pressed portion are disposed adjacent to each other, the second reference member and the second pressed portion are disposed adjacent to each other, and the third reference member and the third pressed portion are disposed adjacent to each other.

6. The liquid discharge head according to claim 5, wherein the third pressed portion is disposed, with respect to the third reference member, in a direction toward a midpoint of a line segment connecting the first reference member and the second reference member in the first direction.

7. The liquid discharge head according to claim 5, wherein the first pressed portion and the second pressed portion are disposed, with respect to the first reference member and the second reference member, in a direction toward a midpoint of a line segment connecting the first reference member and the second reference member in the first direction.

8. The liquid discharge head according to claim 1, wherein each of the first pressed portion, the second pressed portion, and the third pressed portion includes an opening and is pressed against the predetermined portion by a screw passing through the opening.

9. The liquid discharge head according to claim 1, wherein the reference member positions the discharge element substrate by bringing a positioning portion into contact with the predetermined portion.

10. The liquid discharge head according to claim 1, wherein a center of gravity of a surface on which the plurality of discharge ports is formed is inside the first triangle.

11. The liquid discharge head according to claim 1, wherein a difference between a center of gravity of the first triangle and a center of gravity of the second triangle in the first direction is one-sixth or less of a line segment connecting the first reference member and the second reference member.

12. A liquid discharge head comprising:
a discharge element substrate including a plurality of discharge ports through which liquid is discharged, the plurality of discharge ports forming a discharge port array along a first direction;
a support member on which the discharge element substrate is disposed, the support member being configured to support the discharge element substrate with respect to a predetermined portion; and
a reference member disposed at the support member and configured to position the discharge element substrate with respect to the predetermined portion,
wherein the reference member includes:
a first reference member and a second reference member disposed at a first end portion in a second direction orthogonal to the first direction so that the first reference member and the second reference member are positioned at different locations in the first direction; and
a third reference member disposed at a second end portion opposite the first end portion in the second direction,
wherein the support member includes, as a pressed portion configured to receive a force for pressing the predetermined portion:
a first pressed portion and a second pressed portion disposed at the first end portion so that the first pressed portion and the second pressed portion are positioned at different locations in the first direction; and
a third pressed portion at the second end portion,
wherein the first pressed portion is disposed near the first reference member, the second pressed portion is disposed near the second reference member, and the third pressed portion is disposed near the third reference member.

13. A liquid discharge apparatus comprising:
a liquid discharge head; and
a predetermined portion,
wherein the liquid discharge head includes:
a discharge element substrate including a plurality of discharge ports through which liquid is discharged, the plurality of discharge ports forming a discharge port array along a first direction;
a support member on which the discharge element substrate is disposed, the support member being configured to support the discharge element substrate with respect to the predetermined portion; and
a reference member disposed at the support member and configured to position the discharge element substrate with respect to the predetermined portion,
wherein the reference member includes:
a first reference member and a second reference member disposed at a first end portion in a second direction orthogonal to the first direction so that the first reference member and the second reference member are positioned at different locations in the first direction; and
a third reference member disposed at a second end portion opposite the first end portion in the second direction,
wherein the support member includes, as a pressed portion configured to receive a force for pressing the predetermined portion:
a first pressed portion and a second pressed portion disposed at the first end portion so that the first pressed portion and the second pressed portion are positioned at different locations in the first direction; and
a third pressed portion at the second end portion,
wherein a first triangle formed by connecting a first reference point defined by the first reference member, a second reference point defined by the second reference member, and a third reference point defined by the third reference member has a center of gravity inside a second triangle formed by connecting three points of the first pressed portion, the second pressed portion, and the third pressed portion.
